(19) United States
(12) Patent Application Publication
(10) Pub. No.: US 2016/0044929 A1
(43) Pub. Date: Feb. 18, 2016

(54) Animal Gassing Module

(71) Applicants: Gregory Michael MCMAHON, (US); Stuart Charles HOWES, (US)

(72) Inventors: Gregory Michael McMahon, Samford, QL (AU); Stuart Charles Howes, Kootingal, NS (AU)

(21) Appl. No.: 14/779,112

(22) PCT Filed: Apr. 9, 2014
(86) PCT No.: PCT/AU2014/000380

§ 371 Date: Sep. 22, 2015

(30) Foreign Application Priority Data
Apr. 12, 2013 (AU) 2013901267

(51) Int. Cl. A22B 3/00

(52) U.S. Cl. CPC A22B 3/005

(57) ABSTRACT

An erectable module for gassing animals, the module including a frame and at least one cover being supported by the frame to define a chamber.

### TECHNICAL FIELD

The present invention generally relates to harvesting animals for slaughter and use in the food industry and, more particularly, to a device for euthanizing animals on an industrial scale. The present invention has particular application to poultry.

### BACKGROUND

The harvesting of animals for slaughter can be an inhumane and gruesome process that can be traumatic for the animals and the people harvesting those animals. The inhumane nature of the harvesting process can be exemplified by the following description of current practice in the chicken farming industry.

Free range chicken farms typically comprise at least one large barn (which is approximately 100 m long and 12 m wide) which may contain around 15,000 chickens. Before slaughtering the chickens, the chickens are given no food or water for 12 hours to reduce the amount of excrement and urine within their bodies. The chickens are then gathered in the barn and corralled down temporary, purpose built tunnels within the barn. Workers then grab the chickens by the legs as they emerge at the end of the tunnels and shove the chickens into cages. The cages are typically 2.8 metres wide, 1.05 metres depth and 1.55 metres high. Around 30 or more birds are put into each cage. The conditions are cramped.

Putting the chickens in cages can be a brutal process, as the farmer's workers generally have little regard for animals which are shortly destined for slaughter. The workers must psychologically desensitise themselves to cruelty, or be individuals who have such inclinations naturally. The chickens are often injured and stressed whilst being captured and may sustain broken limbs and bruising. This can be a difficult process for the farmer to watch or partake, because he or she has raised those chickens from hatchlings with a relative degree of kindness and has treated those chickens as pets to some extent.

A great deal of noise is created by the chickens within the barn during the harvesting process. This noise often carries to neighbouring barns containing other chickens and creates a great deal of distress amongst those chickens. Thereafter, those other chickens often flee at the sight of the farmer and his workers, as they now are aware of what humans are capable of. The intelligence of these birds is often underestimated.

The caging process typically takes 6 to 9 hours. The chickens are left in cages outside the barn, in the sun, before being loaded by forklift onto semi-trailer trucks and driven to a slaughterhouse. Most truck drivers prefer to drive in groups and will not leave the farm with the chickens until all of the cages have been loaded onto all of the trucks at the end of the day. Slaughterhouses are often located many hours travel from chicken farms. Most chickens will not survive the caging process and journey to the slaughterhouse due to shock, injury, dehydration and/or fatigue.

At the slaughterhouse, the chickens are removed by hand from the cages and placed upside down on hooks, which clasp their feet and often penetrate the skin of the chicken. This can be an incredibly painful and distressing process for those chickens which are still alive. The chickens are then typically passed into a water bath with an electric current running through it to electrocute them.

When battery chickens (which are kept in cages) are to be slaughtered, the common practice is to remove each chicken from its cage by hand and then break their necks. The chickens are then thrown into a portable storage container along with other chickens. However, this frequently does not kill the chicken, but merely paralyses it. In this situation, the chicken is still able to experience pain and suffering after its neck has been broken and it has been thrown into the storage container.

If a serious disease outbreak occurs within a population of chickens, there are a number of other methods of exterminating the chickens. One method involves gathering the chickens in a barn, opening canisters filled with carbon dioxide gas and draping large sheets of plastic over the chickens and gas canisters to suffocate the chickens. The gas escapes directly into the environment because the sheet of plastic only contains the gas momentarily and the barn itself is unsealed. This gas can be fatal to humans. Workers must wear gas mask respirators. A large amount of gas is wasted using this method. This drastic method of exterminating chickens is only employed in emergency situations and is not cost effective for general industrial use. The dead chickens are then buried between layers of sawdust. Another method of exterminating diseased chickens is to set the diseased birds on fire whilst they are still alive (this method of extermination is known to have been practiced in Indonesia).

Hence, a more humane and efficient method of harvesting animals for slaughter is desired. The preferred embodiment of the present invention is directed to an improved device for slaughtering animals, which may at least partially overcome at least one of the abovementioned disadvantages or provide the consumer with a useful or commercial choice.

The reference to any prior art in this specification is not, and should not be taken as an acknowledgement or any form of suggestion that the prior art forms part of the common general knowledge.

### SUMMARY OF INVENTION

According to a first aspect of the present invention, there is provided an erectable module for gassing animals, the module including a frame and at least one cover being supported by the frame to define a chamber.

Preferably, the frame is formed from an interconnected three-dimensional lattice of inflatable tubes. Advantageously, the frame may be inflated on site to gas the animals. The frames are adapted to be connected in series so as to form a module network.

The tubes may have one or more internal bladders surrounded by an external sleeve, so that the tubes can withstand a higher degree of pressure.

In some forms of the invention, the frame is frame is unitary. However, in other forms of the invention, the frame may comprise discrete sections adapted to be connected to form a module. Discrete sections may be used when a module is required to surround an existing structure such as battery cages.

Preferably, the animals are euthanized when gassed. However, the modules may also be used to anesthetize animals. The preferred gas is carbon dioxide. The level of this gas inside the chamber can be used to either euthanize or anesthetize the animals.

The gas could be trapped in a liquid, such as foam. Conventional fire-fighting foam can be used to euthanize the chickens. Alternatively, the gas can be trapped in a solid form, such as absorbent granules which are adapted to release a poisonous gas.

The erectable module may comprise a removable roof portion. The cover may include a single sheet or multiple sheets of material for affixing onto the frame. The material may be formed from polymeric material.

The device may include a gas conduit for introducing gas into the chamber. The device may include a pump for pumping gas in or out of the conduits.

The frame may include a plurality of handles to facilitate handling. Anchor means may be used on the frame so that ground pegs or weights may be fastened to the device.

According to a second aspect of the present invention, there is provided a device for gassing animals, the device including:
(a) a frame having at least one inflatable portion;
(b) at least one cover being supported by the frame to define a chamber; and
(c) means for supplying gas into the chamber in which the animals are located.

According to a third aspect of the present invention, there is provided a method of euthanizing chickens on a free-range farm having a barn, the method comprising:
(a) installing one or more modules defining a gas chamber outside the barn;
(b) ejecting chickens from a barn during the day,
(c) closing the doors to the barn so as to prevent the chickens from re-entering the barn;
(d) opening the modules before nightfall;
(e) allowing the chickens to roost underneath the modules;
(f) sealing the modules; and
(g) gassing the chickens.

According to a fourth aspect of the present invention, there is provided a method of euthanizing chickens on a free-range farm having a barn, the method comprising:
(a) installing one or more modules defining a gas chamber inside the barn;
(b) closing the doors to the barn so as to prevent the chickens from exiting the barn;
(c) waiting until nightfall;
(d) entering the barn;
(e) placing the chickens inside the modules;
(f) sealing the modules; and
(g) gassing the chickens.

According to a fifth aspect of the present invention, there is provided a method of euthanizing chickens on a free-range farm having a barn, the method comprising:
(a) installing one or more modules defining a gas chamber adjacent to a door of the barn;
(b) driving the chickens through the door and into the modules;
(c) closing the door to the barn;
(d) sealing the modules; and
(e) gassing the chickens.

According to a sixth aspect of the present invention, there is provided an erectable module for gassing animals inside an animal shelter, the module comprising one or more retractable covers to define a chamber within the animal shelter.

The animal shelter may be a barn for poultry. Preferably, the retractable covers are awnings made of PVC. The awnings should be gas impervious. A first awning can be mounted on the roof of the barn and drawn downwards to the floor of the barn. A second awning can be mounted beneath a mesh floor of the barn and retracted or extended from outside the barn. The first and second awnings form a chamber inside the barn for gassing the poultry. The awnings can be extended or retracted using a manually or automatically operated crank.

Any of the features described herein can be combined in any combination with any one or more of the other features described herein within the scope of the invention.

### BRIEF DESCRIPTION OF DRAWINGS

Various embodiments of the invention will be described with reference to the following drawings, in which:

FIG. 1 is an illustration of a series of rectangular and triangular shaped modules according to the present invention, in use by a farmer next to a chicken barn.

FIG. 2 is a perspective view of the rectangular module of FIG. 1.

FIG. 3 is a perspective view of the rectangular module of FIG. 2 at a first stage of assembly.

FIG. 4 is a side perspective view of the rectangular module of FIG. 2 at a second stage of assembly.

FIG. 5 is a perspective view of a fanner accessing a gas canister in a rectangular module using a built in glove.

FIG. 6 is a perspective view of the triangular shaped module of FIG. 1.

FIG. 7 is a perspective view of a module network according to another embodiment of the present invention, in use on a battery of chicken cages.

FIG. 8 is a perspective view of a dome-shaped module according to another embodiment of the present invention.

FIG. 9 is a side view of an assembly of operating the rectangular module of FIG. 1 inside a barn.

### DESCRIPTION OF EMBODIMENTS

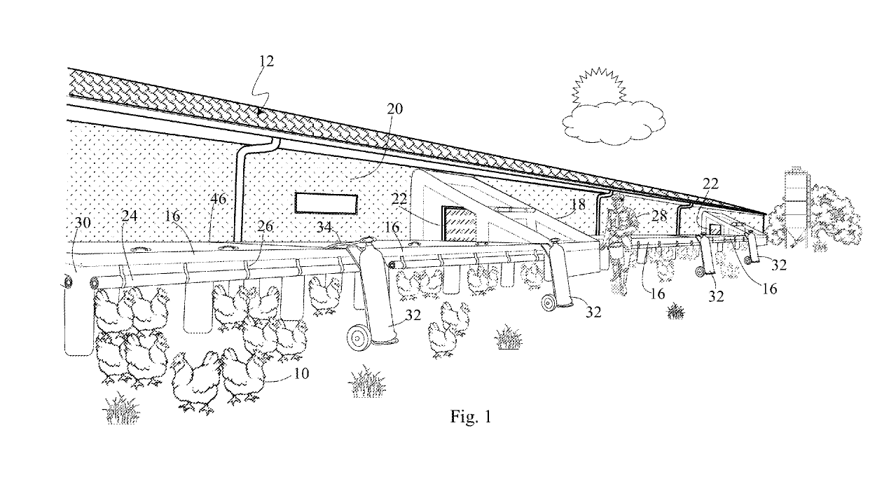

Chickens 10 on free range farms are typically housed in a large barn, such as barn 12 shown in FIG. 1. These types of barns typically hold around 15,000 chickens. The chickens 10 enter and exit the barn 12 via doors 14. The chickens 10 are kept within the barn 12 overnight and the doors 14 are closed to protect the chickens from predators, such as foxes or dogs. The chickens 10 on the highest pecking order will ordinarily come out of the barn 12 when the doors 14 are opened in the morning. Chickens 10 which are lower on the pecking order may never come out of the barn 14.

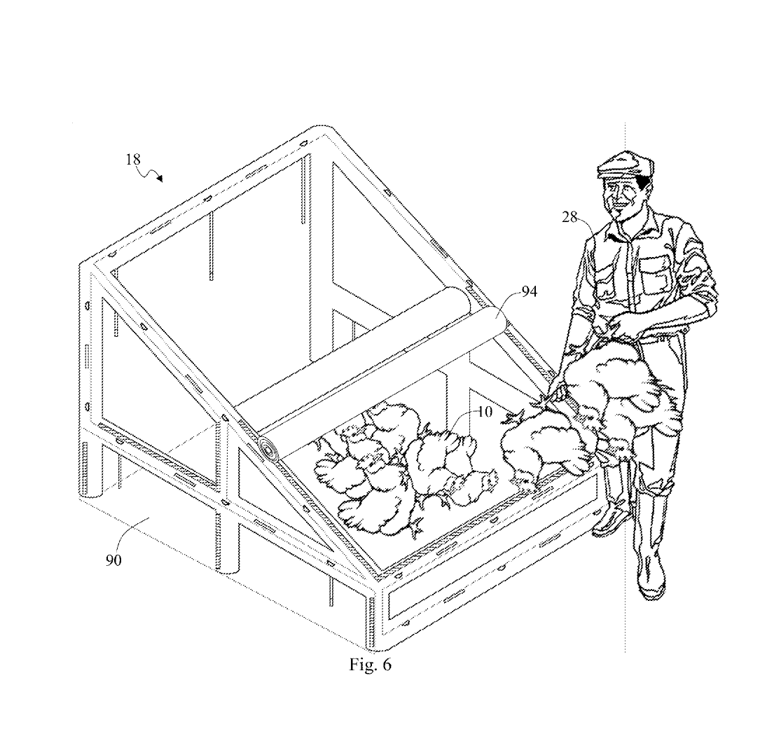

Rectangular modules 16 and triangular modules 18 according to the present invention are placed alongside the walls 20 of the barn. Triangular modules 18 (see also FIG. 6) can be placed in front of the doors 22 of the barn 12. The modules 16 and 18 can be connected in series by rolling up the side panels 24 of the modules 16 and the side panels 90 of the triangular modules 18 (see FIG. 6). The side panels 24 can be held up by means of a clip and strap mechanism 26.

The chickens 10 can be driven into the triangular modules 18 from inside the barn 12, or they can voluntarily huddle under the rectangular modules 16 and triangular modules 18.

Any chicken 10 which leaves the barn 12 will return to the barn 12 to roost before nightfall for a sense of security. If the doors 22 to the barn 12 are shut before the chickens 10 return to the barn 12 to roost, the natural tendency of the chickens 10 is to huddle against the walls 20 the barn for security. If the doors 22 to the barn 12 are shut before the chickens 10 can re-enter the barn 12, the chickens 10 will seek any shelter they can find near the walls 20 of the barn 12. The modules 16 and 18 provide that apparent shelter. The chickens naturally go to sleep huddled together on mass. Unless the chickens are greatly disturbed in the dark, they will not move as they have very poor night vision.

Once a sufficient amount of chickens 10 have entered the modules 16 and 18, the side panels 20 may be rolled down and zipped shut. The zips, such as zip 30 in FIG. 1, may have covers over them to prevent the ingress of dirt within the zip and to prevent the escape of the gas from the modules.

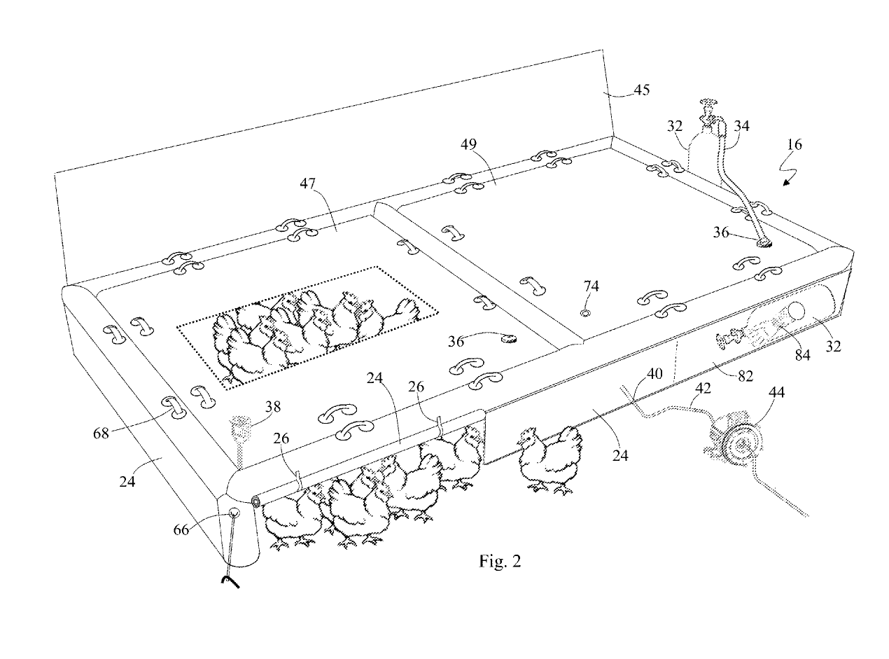

The farmer 28 may connect gas canisters 32 via conduits 34 to input valves 36 on the modules 16 (see FIG. 2). The pressure from the canister 32 distributes the gas within the modules 16. Carbon dioxide is used to asphyxiate the chickens 10.

A standard hose connection for a gas canister may freeze due to the pressure and speed at which the gas emerges from the canister. One means of overcoming this problem is to have a wider hose so that the gas is not forced at high speed through the valve of the canister. A larger orifice from the canister leading into hose of a 5 cm diameter is effective in transferring gas over distance without freezing (see FIG. 2).

A certain level of carbon dioxide will anesthetize the chickens 10 (i.e. render the chickens unconscious), but a higher level of carbon dioxide will euthanize the chickens 10. In some situations, the chickens may need to be anesthetized, rather than euthanized. Chickens may need to be anesthetized before their beaks are clipped. A machine is used to clip the chicken's beaks. The clipping process can be distressing for the chickens. If the chicken's heads are not correctly aligned within the clipping machine, an inexperienced operator of the clipping machine may prematurely remove the chicken from the machine and break the jaw of the chicken during the process. The jaws of chickens are often broken during the clipping process.

As shown in FIG. 2, each module 16 may comprise a gas meter 38, so that the farmer 28 may ascertain the gas level inside the module 18. The modules 18 may comprise a gas extraction outlet 40 so that a hose 42 connected to a pump 44 may be used to expel the carbon dioxide gas at a safe distance from the module 16 (for occupational health and safety reasons). The pump 44 can be used to assist with the transfer of gas from one module to the next by connecting the outlet of one module to the inlet of another.

The rectangular modules 16 can also be placed inside the barn 12. The internal floor of the barn 12 (not shown) is typically comprised of grates which are suspended above the ground. Chicken faeces drop through the grates onto the ground, which is approximately 1 meter beneath the grates. Accordingly, a plastic sheath (not shown) is required to be placed underneath the modules 18, so that the gas cannot escape from beneath the modules 16 and asphyxiate the user, such as farmer 28.

In another form of the invention, fire extinguishing foam may be introduced into the modules 16 to suppress the oxygen levels and thereby asphyxiate the chickens 10. In this embodiment of the invention, the foam may be introduced into an orifice (not shown) located at the centre of roof panels 47 and 49 (see FIG. 1) of the module 16. A flange located underneath the orifice inside the module 16 may be used to ricochet and disperse an incoming stream of foam around the inside of the module 16.

In other forms of the invention, the gas could be produced by granules impregnated with a poisonous agent, such as hydrogen cyanide (prussic acid). These granules could be introduced into the modules to poison the animals.

Chicken barns are often constructed so that the ground slopes away from the walls of the barn. Accordingly, an awning 45 may be used to fasten the module to the wall 20 of the barn 12 to prevent the module 16 from sliding down the slope. The awning 45 may have side drapes (not shown) to prevent chickens 10 from accessing the area under the awning 34 between the module 16 and the wall 20 of the barn 12. It could be difficult for the fanner 28 to remove chickens 10 from behind the awning 45, particularly if multiple modules are joined in a series.

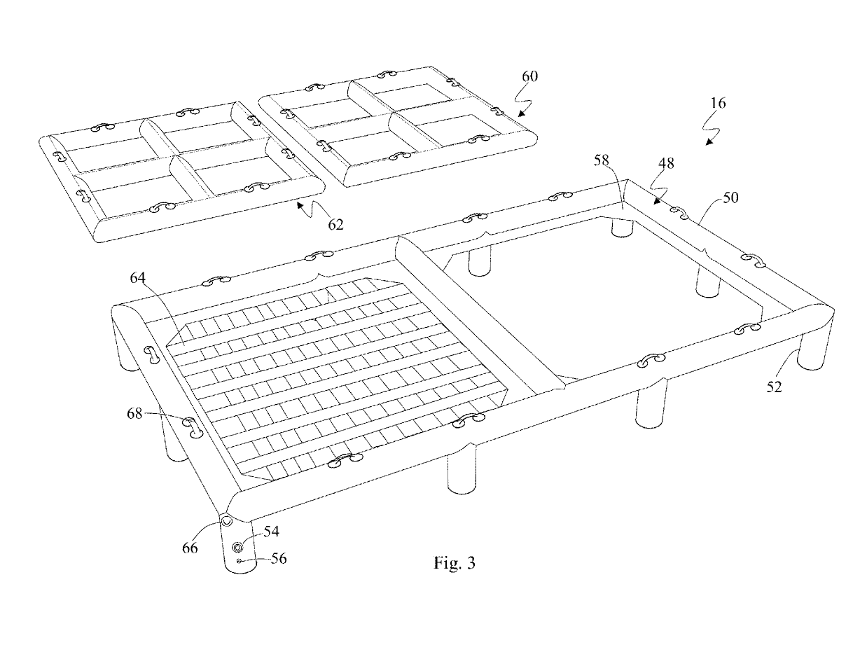

FIG. 3 shows the internal components of the module 16. The module 16 has a frame 48 with horizontal supports 50 and vertical struts 52. The modules 16 are made of plastic and the frame 48 is inflatable to reduce the overall weight of the modules 16. This confers a number of advantages on the invention, including enabling a single user to readily lift and move the light frame 48 and retrieve the dead chickens underneath it. In addition, the inflatable frame 48 can be deflated and readily stored or transported when not the module 16 is not in use. Plastic is also a cheap and readily available material for mass production of the modules.

In another embodiment, the frame 48 could include an internal inflatable bladder covered by an external sleeve (e.g. of one or more layers of polyvinyl chloride), which would enable the construction of stronger (and lighter) but slimmer frames. The bladder allows an increased amount of pressure to be introduced into the frame 48. The strength of the frame 48 depends on the amount of pressure in it. A normal frame 48 with no bladder would burst under the pressure which can be introduced into the bladder/sleeve system.

In an alternative embodiment of the present invention, the frame 48 could be filled with extruded polystyrene foam (e.g. Styrofoam™).

The seams of the module 16 are heat-welded, so that the seams will not leak (unless punctured). A blower would be required to keep the module continuously inflated if the seams are stitched rather than welded, as stitches are not air-tight.

The frame 48 is inflated at a single inflation valve 54 (see FIG. 3). The frame 48 can incorporate a relief valve 56 to prevent the accidental over-inflation of frame 48 by a user.

The frame 48 has a recess channel 58 for supporting a first roof lattice 60. The embodiment of the invention shown in FIG. 3 also has a second roof lattice 62. Each roof lattice 60 and 62 may be separated from the frame 48, so that the farmer 26 may readily retrieve or place chickens within the module 16.

In some embodiments of the invention, the frame 48 can have a mesh 64 to allow ventilation for chickens when the roof lattice 62 has been removed. The mesh 64 also prevents the escape of the chickens from within the module 16 when the roof lattice 62 is opened.

The lattices 60 and 62 have covers (see FIG. 2) made of an air impervious material polymeric plastic material such as PVC. The covers can be opaque or transparent. Chickens are likely to feel a greater sense of security within the module 18 if the panels are opaque. However, it may be useful for at least a portion of the covers to be transparent so that the farmer can see how many chickens are inside the module 16.

One or more anchor lugs 66 may be positioned around the frame 48 to connect to a rope to a peg for insertion into the ground (as shown in FIG. 2), or weights to hold the frame 48 down. The frame 48 and roof lattices 60 and 62 may have one or more handles 68 attached to it to facilitate handling.

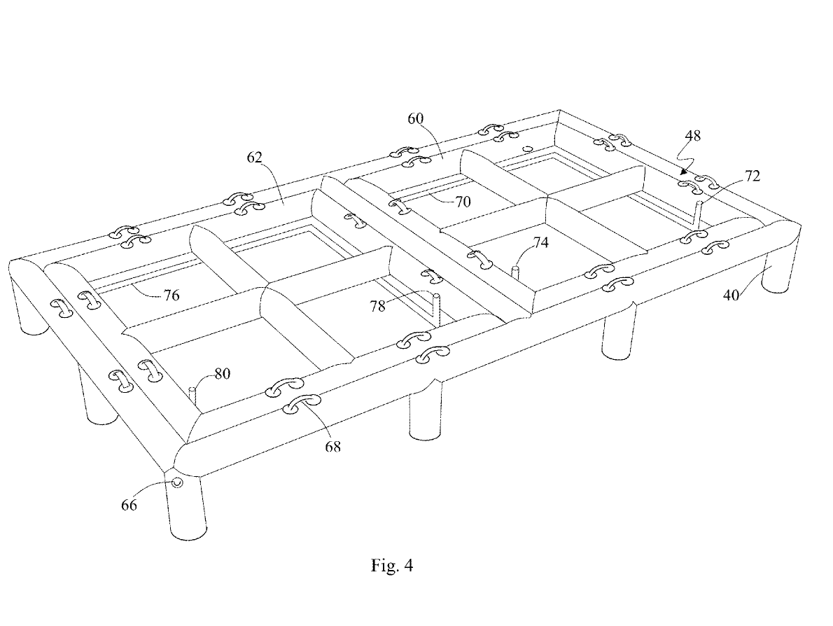

FIG. 4 shows a first gas conduit 70, having an inlet 72 and an outlet 74, which is connected to the roof lattice 60. The conduit 70 may be perforated so that it may distribute the gas evenly around the interior of the module 16. The second roof lattice 62 also has a gas conduit 76 which has an inlet 78 and an outlet 80. The outlet 74 can be connected to an inlet 78. A pump (not shown) can be used to draw the gas from the first gas conduit 70 through to the second gas conduit 76.

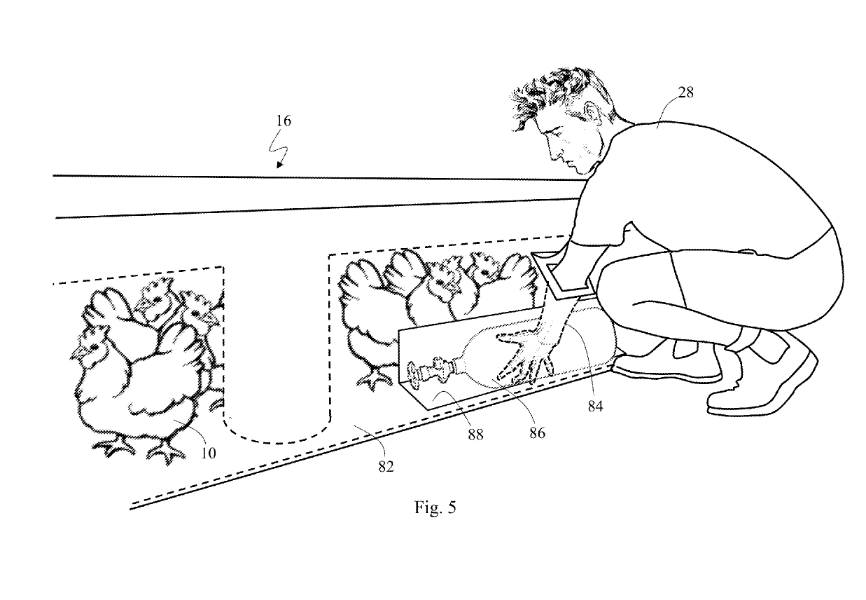

FIG. 5 shows another means of introducing gas into the module 16. In this embodiment of the invention, a front panel 82 of the module 16 has an in-built glove 84, so that the farmer 28 can reach inside the module 16 and open the gas canister 86. This method of operating the invention quickly releases the gas into the module 16. The quicker the gas is released into the module 16, the quicker the chickens 10 are euthanized and the less suffering they experience. The gas canister 86 can be placed next to a metal baffle plate 88 so that the jet stream of gas emerging from the canister 86 does not hurt a chicken before euthanizing it.

A base panel (not shown) for the module 16 is required when the module 16 is to be used inside a chicken barn. This is because the floor of a typical chicken barn is comprised of plastic slats that are perforated with holes for manure to pass through to the ground, which is typically around 1 metre beneath the slats. The gas could escape through the slats and pose a safety hazard if the module 16 does not have a base panel in these circumstances.

FIG. 6 shows the triangular shaped module 18 in more detail. In particular, the module 18 has side panels 90 which can be rolled up, so that it can connect with a rectangular shaped module 16 (as shown in FIG. 1). The module 18 is shaped as a triangle because the large side 92 is adapted to cover the door 22 of the chicken barn 20. The module 18 has a top-panel 94, which can be rolled up so that the farmer can access the chickens 10 within the module 18.

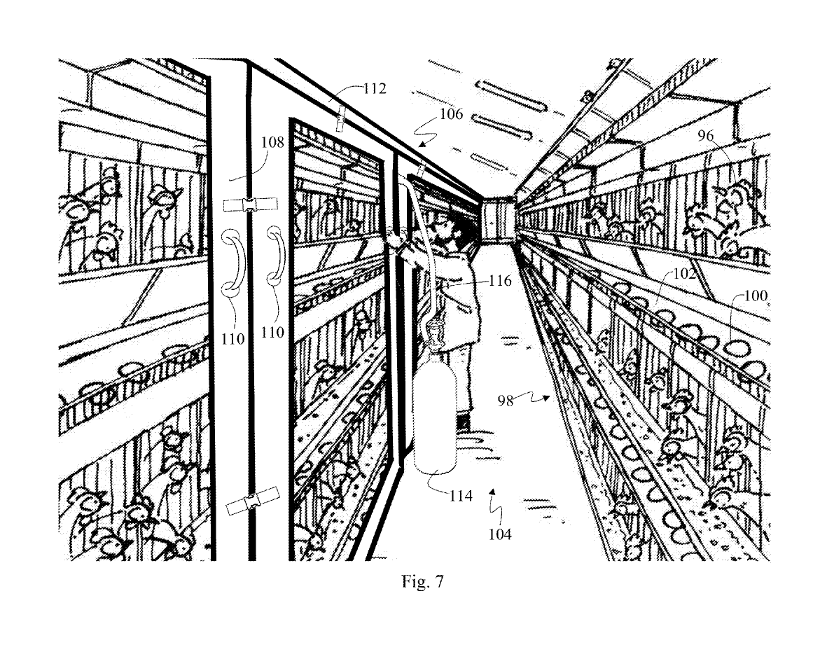

FIG. 7 shows another embodiment of the invention for chickens 96 in battery cages 98. These chickens 96 are kept in the cages 98 for their entire life. They lay eggs 100 in their cages 98, which are then automatically rolled onto conveyor belts 102. When the hens 96 reach a certain point in their lifetimes, they no longer produce an efficient amount of eggs per day. Consequently, they have to be exterminated and replaced with new chickens. The process of extermination is brutal and involves removing each chicken 96 from its cage 98 by hand and breaking its neck. This often paralyses the chicken rather than kills it. The paralysed chickens are then thrown into a storage container which moves down the aisle 104 between the cages 98. The paralysed chickens can still experience pain and distress before they die. The dead chickens are then sold off to the meat market. Obviously, it would be more humane if the chickens 96 experienced little or no pain before a quick death.

One solution to this problem is provided in the form of module 106. The module 106 encompasses the cages 98 to euthanize the chickens 96. As shown in FIG. 7, the farmer 28 places vertical panels 108 against the front of the cages 98 using the handles 110. One or more horizontal panels 112 are placed on top of the cages 98 to create a seal with the vertical panels 108 and form the module 106. Carbon dioxide gas can be transferred into the module 106 from a canister 114 via a hose 116. This suffocates the chickens 96 so that they can be easily removed from their cages 98.

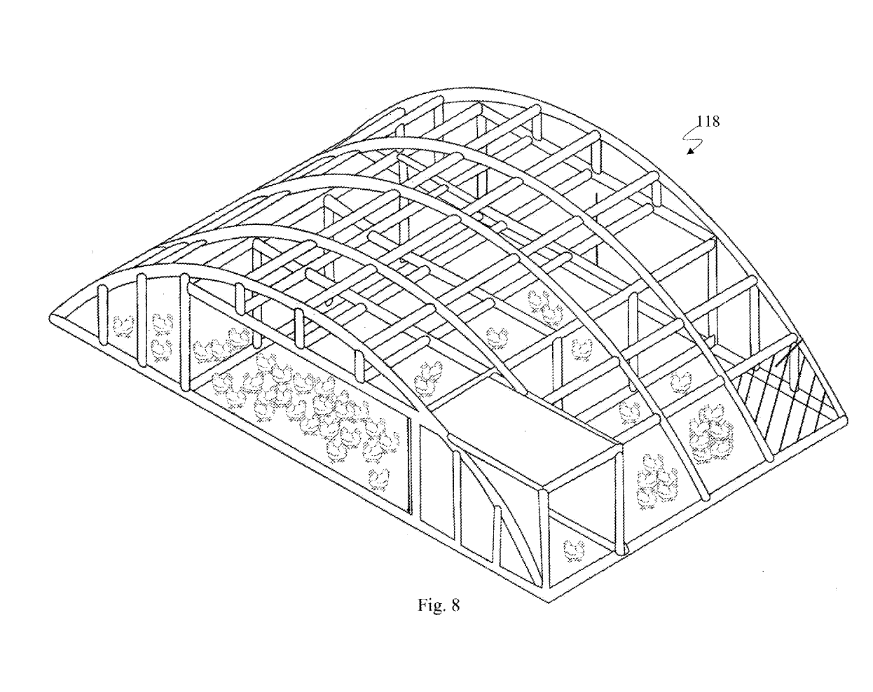

Modules of any shape or size can be made according to the present invention. For example, FIG. 8 shows another embodiment of the invention in the form of a dome shaped module 118, including a lattice framework which can cover a large area and many chickens.

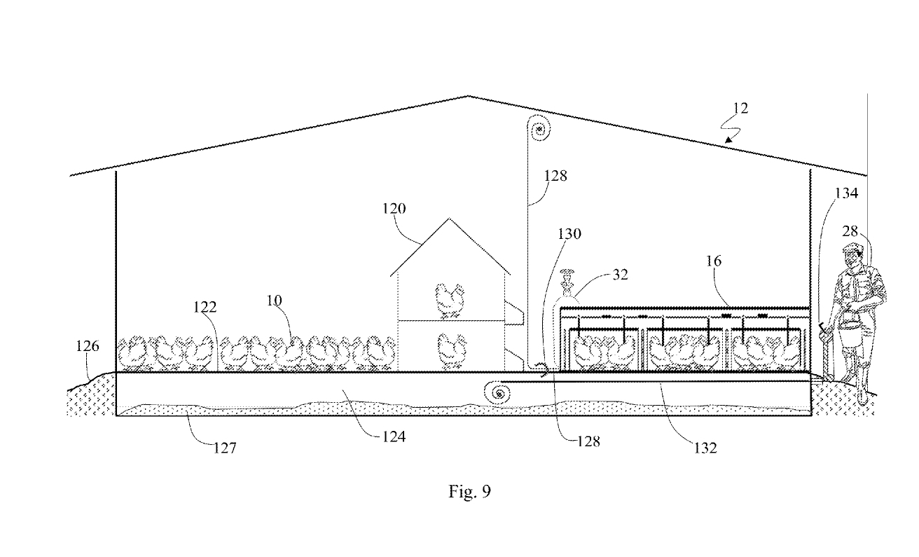

FIG. 9 shows a side section view of the barn 12 of FIG. 1. The barn 12 has a hutch 120 in which the chickens 10 lay their eggs. The hutch 120 runs the length of the barn 12 and divides it into two halves. The barn 12 has a floor 122 which sits above a trench 124. The trench 124 is dug beneath ground level 126 outside the barn 12. The floor 122 is made of a series of slats which have a mesh that allows the manure 127 of the chickens 10 to pass through to the trench 124.

One or more modules 16 are placed in the barn 12 along with one or more gas canisters 32. If gas is pumped into a module 16 which does not have a base, it would escape through the mesh in the floor 122 and potentially suffocate the farmer 28.

In order to overcome this problem, the barn 12 has an assembly according to present invention to contain the gas. A first part of the assembly is an awning 128 which is drawn from roof of the barn 12 to the floor 122 of the barn 12. The awning 128 should be drawn partially along the floor 122 and secured using a hook 130 to create a seal. The awning 128 divides the right hand side of the barn 12 from the left hand side. Another part of the assembly is an awning 132, which can be extended and retracted under the floor 122 of the barn 12 using a crank 134. The awnings 128 and 132 form a chamber on the right hand side of the barn 12.

The chickens 10 on the right hand side of the barn 12 can be herded into the modules 16. The gas canisters 32 can then be opened to gas the chickens 10 in the right hand side of the barn 12. The gas can then slowly dissipate outside the barn 12 so that the chickens 10 on the left hand side of the barn remained unharmed.

In other embodiments of the invention, the modules 16 may not be required and the awnings 128 and 132 can form an erectable module in which to euthanize the chickens. However, in this embodiment of the invention, more gas is required to fill the volume of space defined by the awnings 128 and 132.

Various embodiments of the frame of the module are within the scope and ambit of the present invention. In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

What is claimed is:

1. A module capable of gassing animals comprising
an inflatable frame,
at least one cover being supported by the inflatable frame to define a chamber; and
a means of introducing a noxious gas into the chamber to gas animals.

2. The module of claim 1, wherein the inflatable frame is formed from an interconnected three-dimensional lattice of inflatable tubes.

3. The module of claim 1, wherein the inflatable frame is adapted to be connected together in series with one or more additional inflatable frames so as to form a module network.

4. The module of claim 2, wherein each of the inflatable tubes comprises an internal bladder and an external sleeve.

5. The module of claim 1, wherein the inflatable frame is unitary.

6. The module of claim 1, wherein the inflatable frame comprises discrete sections adapted to be connected together.

7. The module of claim 3, wherein the module network comprises conduits for circulating gas around the module network.

8. The module of claim 2, wherein the inflatable tubes include a relief valve.

9. The module of claim 1, wherein the module network comprises a removable roof portion.

10. The module of claim 1, wherein the inflatable frame comprises a polymeric material.

11. The module of claim 1, wherein the noxious gas is used to euthanize or anesthetize the animals.

12. The module of claim 1, wherein the noxious gas is trapped in a liquid to produce foam and released inside the chamber.

13. The module of claim 1, wherein the noxious gas is trapped in a solid such as absorbent granules and released inside the chamber.

14. A method of euthanizing chickens on a free-range farm having a barn, the method comprising:
(a) installing one or more modules defining a gas chamber outside a barn;
(b) ejecting chickens from the barn during the day,
(c) closing the doors to the barn so as to prevent the chickens from re-entering the barn;
(d) opening the one or more modules before nightfall;
(e) allowing the chickens to roost underneath the one or more modules;
(f) sealing the one or more modules; and
(g) gassing the chickens.

15. (canceled)

16. A method of euthanizing chickens on a free-range farm having a barn, the method comprising:
(a) installing one or more modules defining a gas chamber adjacent to a door of a barn;
(b) driving chickens through the door and into the one or more modules;
(c) closing the door to the barn;
(d) sealing the one or more modules; and
(e) gassing the chickens.

17. An erectable module for gassing animals inside an animal shelter, comprising
one or more retractable covers to define a chamber within an animal shelter.

18. The erectable module of claim 17, wherein the animal shelter is a barn for poultry.

19. The erectable module of claim 18, wherein the one or more covers comprise a first awning which is drawn down from a roof of the barn and a second awning which is drawn beneath a floor of the barn, so that the first and second awnings form the chamber with the barn.

20. A module capable of gassing animals comprising
an inflatable frame;
at least one cover being supported by the inflatable frame to define a chamber; and
a means of introducing an immobilising substance into the chamber to immobilise the animals.

21. A module capable of gassing animals comprising
an inflatable frame; and
at least one cover being supported by the frame to define a chamber, wherein the inflatable frame is adapted to dock with a door of an animal enclosure so that the animals can be directed into the inflatable frame.
